(19) United States
(12) Patent Application Publication
(10) Pub. No.: US 2011/0235701 A1
(43) Pub. Date: Sep. 29, 2011

(54) SCALABLE VIDEO BROADCASTING APPARATUS AND METHOD OVER MULTIBAND SATELLITE CHANNEL

(75) Inventors: Seungchul Kim, Daejon (KR); Min-Su Shin, Daejon (KR); Euna Choi, Daejon (KR); Joongyu Ryu, Daejon (KR); Dae-Ig Chang, Daejon (KR)

(73) Assignee: Electronics and Telecommunications Research Institute, Daejon (KR)

(21) Appl. No.: 12/809,451

(22) PCT Filed: Sep. 4, 2008
(86) PCT No.: PCT/KR2008/005228

§ 371 Date: Jun. 18, 2010

(30) Foreign Application Priority Data
Dec. 18, 2007 (KR) 10-2007-0133763

(51) Int. Cl. H04N 7/26

(52) U.S. Cl. 375/240.02; 375/E07.126

(57) ABSTRACT

Provided is an apparatus and method for transmitting/receiving multiband broadcasting using scalable video coding, which can solve a limitation of a transmission band in a multichannel satellite broadcasting service and increase availability of a satellite broadcasting service by scalably encoding video data and transmitting the data using a different transmission band for each layer. The apparatus for transmitting multiband broadcasting using scalable video coding includes: a scalable video encoder for scalably encoding video data to generate a scalable video stream having multiple layers; a multiplexer for multiplexing the scalable video elementary stream having multiple layers, a compressed audio elementary stream, and program specification information to generate a transport stream (TS); and a multiband transmitter for separating packets of the TS into multiple TSs according to pre-given priority information and transmitting the packet streams using a different transmission band.

### TECHNICAL FIELD

The present invention relates to an apparatus and method for transmitting multiband satellite broadcasting signals based on scalable video coding; and, more particularly, to an apparatus and method for transmitting multiband satellite broadcasting signals based on scalable video coding, which can increase availability of a satellite broadcasting service by scalably encoding video data and transmitting the coded data using a different transmission band for each layer.

This work was supported by the IT R&D program of MIC/IITA [2007-S-008-01, “Development of 21 GHz Band Satellite Broadcasting Transmission Technology”].

### BACKGROUND ART

Bands used for a satellite broadcasting service include a Ku band and a Ka band. A conventional high-definition (HD) satellite broadcasting system provides a satellite broadcasting service using only one of the Ku band and the Ka band. The Ku band refers to a frequency band of 12.5 GHz to 18 GHz or 10 GHz to 14 GHz for satellite communications, and the Ka band refers to a frequency band of 26.5 GHz to 40 GHz or 20 GHz to 30 GHz for the system communications.

Particularly, most conventional satellite broadcasting transmission systems use the Ku band having an excellent transmission characteristic to provide the satellite broadcasting service. For this reason, the Ku band has reached its maximum use efficiency, and thus it is almost impossible to additionally expand the transmission capacity within the corresponding frequency band.

The method that raises the availability of the Ka band can be considered as the way of solving the problem of the transmission band deficit. If the Ka band is properly used together with the Ku band according to the characteristics of the satellite broadcasting services, the frequency-band shortage can be overcome and the use efficiency of the Ka band can be increased.

### DISCLOSURE OF INVENTION

### Technical Problem

An embodiment of the present invention is directed to providing an apparatus and method for transmitting multiband satellite broadcasting based on scalable video coding, which can overcome shortage of a frequency band in a multichannel HD satellite broadcasting service.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

The present invention provides an apparatus and method for transmitting multiband satellite broadcasting based on scalable video, which can scalably encode video data and transmit the coded data using a different transmission band for each layer.

In accordance with an aspect of the present invention, there is provided an apparatus for transmitting multiband satellite broadcasting based on scalable video coding, the apparatus which includes: a scalable video encoder for scalably encoding video data to generate a scalable video elementary stream which has multiple layers; a multiplexer for multiplexing the scalable video elementary stream, a compressed audio elementary stream and program specification information to generate a transport stream (TS); and a multiband transmitter for separating the single TS packet streams into multiple TS packet streams according to pre-given priority information and transmitting the packet streams using a different transmission band.

In accordance with another aspect of the present invention, there is provided an apparatus for receiving multiband broadcasting service using scalable video coding, the apparatus which includes: a multiband receiver for restoring packet streams from broadcasting signals transmitted through different frequency bands and combining the restored packet streams to restore a single transport stream (TS); a demultiplexer for splitting the restored single TS into multiple elementary streams including scalable video elementary stream and audio elementary stream and program specification information; and a video decoder for decoding the scalable video streams.

In accordance with another aspect of the present invention, there is provided a method of transmitting multiband satellite broadcasting using scalable video, the method which includes: scalably encoding video data to generate scalable video stream with multiple layers; multiplexing the generated scalable video elementary stream having multiple layers, compressed audio elementary stream and program specification information to generate a transport stream (TS); and separating the single TS packet stream into TS packet streams having multiple layers according to pre-given priority information and transmitting the packets using a different transmission band.

### Advantageous Effects

In accordance with embodiments of the present invention, in a multichannel broadcasting service, particularly in a multichannel HD satellite broadcasting service, one broadcasting program is separated into two layers by using a scalable video coding (SVC) technology and is separately transmitted using a Ku band and a Ka band. When standard definition (SD) broadcasting using the Ku band is expanded to be high definition (HD) broadcasting, transmission capacity is additionally allocated to the Ka band. Accordingly, it is possible to solve the difficulty of securing additional frequency band for multichannel HD satellite broadcasting service. Also, the low use efficiency of the Ka band can be increased up to a use efficiency level of the Ku band.

In accordance with embodiments of the present invention, an HD broadcasting service of a broadcasting program is provided to a subscriber under the normal weather condition including a normal rainfall by allowing the receiver to receive both Ku-band and Ka-band broadcasting signals. Also, for the same broadcasting program, an SD broadcasting service is provided to the subscriber to prevent service outage under the bad weather condition such as a heavy rainfall or a rainstorm.

Also, in accordance with embodiments of the present invention, excellent transmission characteristics of the Ku band and excellent transmission performance and efficiency offered by DVB-S2 are used based on a scalable transmission concept. Thus, high service availability can be obtained even under the adverse weather condition such as a rainfall. Also, since a wide Ka band is also used, a multichannel HD broadcasting service can be provided.

### BRIEF DESCRIPTION OF THE DRAWINGS

FIG. 1 is a block diagram describing an apparatus for transmitting/receiving multiband satellite broadcasting using scalable video coding in accordance with an embodiment of the present invention.

FIG. 2 illustrates a transport stream generated at a multiplexer (MUX) of FIG. 1 in accordance with an embodiment of the present invention.

FIG. 3 is a block diagram describing a scalable separator of FIG. 1 in accordance with an embodiment of the present invention.

FIG. 4 shows specification information of a program map table (PMT) applied to the present invention.

### MODE FOR THE INVENTION

In accordance with embodiments of the present invention, a system for transmitting digital high-definition (HD) satellite broadcasting generates a base-layer video stream and an enhancement-layer video stream by using a spatial scalable video coding (SVC) technology, and transmits the base-layer video stream using a Ku band while transmitting the enhancement-layer video stream using a Ka band. That is, in accordance with the embodiments of the present invention, a satellite broadcasting service is provided using both Ku and Ka bands.

The advantages, features and aspects of the invention will become apparent from the following description of the embodiments with reference to the accompanying drawings, which is set forth hereinafter. These embodiments are provided so that this disclosure will be thorough and complete, and will fully convey the scope of the present invention to those skilled in the art.

In some embodiments, well-known processes, device structures, and technologies will not be described in detail to avoid ambiguousness of the present invention. Preferred embodiments of the present invention will be described below in more detail with reference to the accompanying drawings.

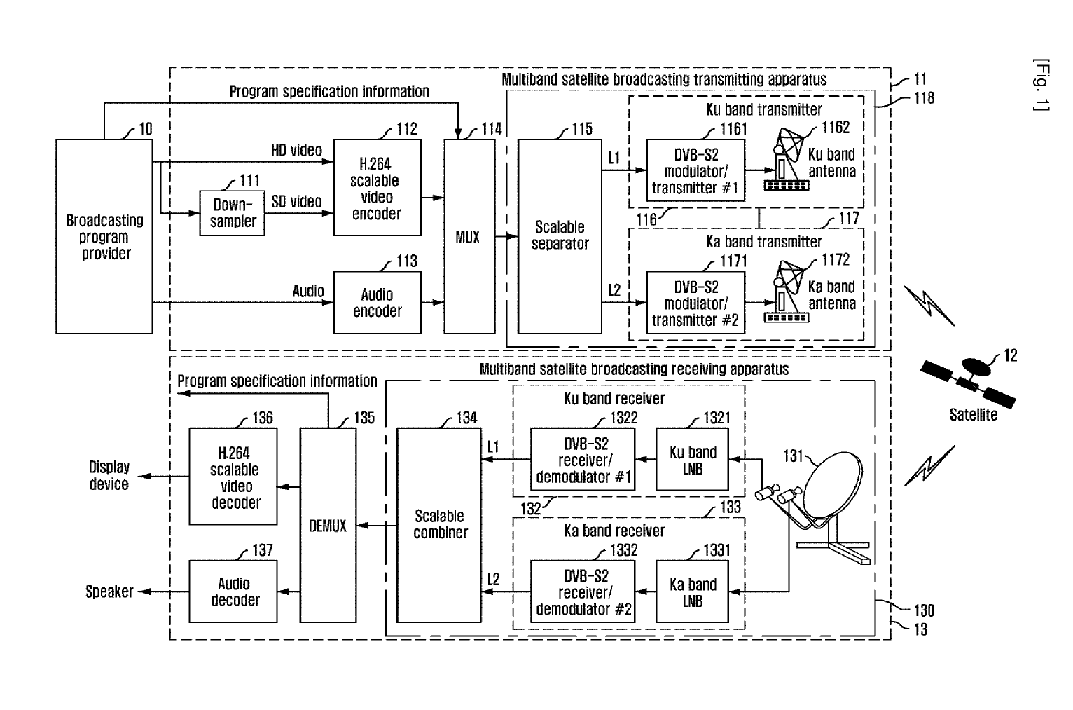

FIG. 1 is a block diagram of an apparatus for transmitting/receiving multiband satellite broadcasting using scalable video coding in accordance with an embodiment of the present invention. A method of transmitting/receiving multiband satellite broadcasting is also explained in description of the apparatus for transmitting/receiving the multiband satellite broadcasting.

An apparatus 11 for transmitting multiband satellite broadcasting in accordance with an embodiment of the present invention will now be described. Referring to FIG. 1, the apparatus 11 for transmitting multiband satellite broadcasting includes a down-sampler 111, an H.264 scalable video encoder 112, an audio encoder 113, a multiplexer 114 (hereinafter, referred to as a MUX), a scalable separator 115, a Ku-band transmitter 116 and a Ka-band transmitter 117. The scalable separator 115, the Ku-band transmitter 116 and the Ka-band transmitter 117 may be collectively called a ‘multiband transmission unit 118’. Each of the elements will now be described.

The down-sampler 111 converts an HD video, i.e., HD resolution video data provided from a broadcasting program provider 10, into standard definition (SD) resolution video data.

The H.264 scalable video encoder 112 generates a spatial scalable video compression stream with respect to the HD resolution video data provided from the broadcasting program provider 10 and the SD resolution video data input from the down-sampler 111.

That is, the H.264 scalable video encoder 112 receives the HD resolution video data provided from the broadcasting program provider 10 and the SD resolution video data, and generates a spatial scalable video stream having two layers, i.e., a base-layer video stream and an enhancement-layer video stream. In accordance with another embodiment, one base-layer video stream and enhancement-layer video streams having multiple layers may be generated.

The two layers are a base layer and an enhancement layer. The base layer corresponds to a compression result of an SD resolution image compatible to the H.264 Advanced Video Coding (AVC) standard, and the enhancement layer corresponds to a result of compression and encoding performed by referencing an input HD resolution image and an encoding result of the base layer according to the H.264 SVC standard. If only a base-layer video stream is decoded, an SD vide may be restored, and if an enhancement-layer video stream is decoded together with the base-layer video stream, an HD video may be restored. The enhancement-layer video stream cannot be decoded alone.

The down-sampler 111 and the H.264 scalable video encoder 112 may be collectively called a ‘video encoder’ because they scalably encode video data provided from the broadcasting program provider 10 and generate scalable video streams having multiple layers.

The audio encoder 113 generates a compressed and encoded audio stream with respect to the audio data input from the broadcasting program provider 10.

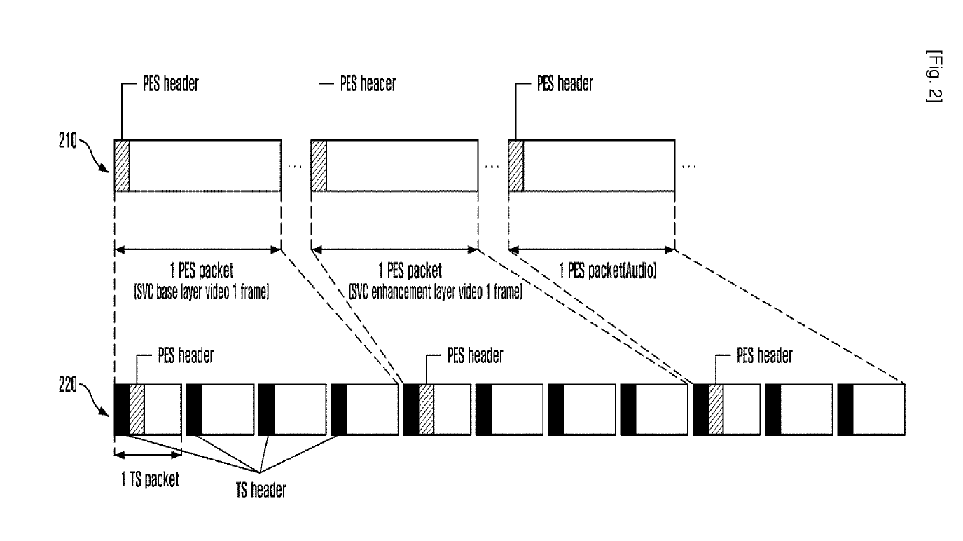

The MUX 114 packetizes and multiplexes video and audio streams compressed and encoded at the H.264 scalable video encoder 112 and the audio encoder 113, and program specification information, i.e., a stream map, thereby generating a Moving Picture Experts Group (MPEG)-2 transport stream (TS). This will be described later with reference to FIG. 2.

The multiband transmission unit 118 separates a TS packet stream into multiple layers according to a data type, and simultaneously transmits them using a different transmission band for each layer. The multiband transmission unit 118 includes the scalable separator 115, the Ku-band transmitter 116 and the Ka-band transmitter 117.

The scalable separator 115 classifies the TS packet generated at the MUX 114 into a first layer (L1) packet stream and a second layer (L2) packet stream according to a corresponding data type. The first layer (L1) packet stream includes a base-layer video packet, an audio packet, and a program specification information packet. The second layer (L2) packet stream includes an enhancement-layer video packet.

The Ku-band transmitter 116 converts the first layer (L1) packet stream into a transmission signal according to the Digital Video Broadcasting-Satellite-Second generation (DVB-S2) standard, up-converts the transmission signal into a Ku band signal, and transmits the up-converted signal via a Ku-band antenna 1162. In more detail, the Ka-band transmitter includes a DVB-S2 modulator/transmitter #1 1161 and the Ku-band antenna 1162.

The DVB-S2 modulator/transmitter #1 1161 performs a transport frame configuration process, an error-correction encoding process and a modulation process on the first layer (L1) packet stream according to the DVB-S2 standard, thereby generating a transmission signal. Thereafter, the Ku-band transmitter 116 up-converts the transmission signal to a Ku-band signal by using a frequency up-converter and a traveling wave tube amplifier (TWTA) so that the transmission signal can be transmitted to the satellite 12.

The Ka-band transmitter 117 converts the second layer (L2) packet stream into a transmission signal according to the DVB-S2 standard, up-converts the transmission signal into a Ka-band signal, and transmits the up-converted signal to the satellite 12 via a Ka-band antenna 1172. In more detail, the Ka-band transmitter 117 includes a DVB-S2 modulator/transmitter #2 1171 and the Ka-band antenna 1172. The DVB-S2 modulator/transmitter #2 1171 may use the same encoding rate and modulation scheme as those of the DVB-S2 modulator/transmitter #1 1161. However, the DVB-S2 modulator/transmitter #2 may apply any encoding rate and modulation scheme suitable for a characteristic of each layer.

To sum up, in accordance with the embodiment of the present invention, HD broadcasting data is scalably encoded into an SD base layer and an HD enhancement layer by using the H.264 SVC technology. Thereafter, the SD base layer requiring relatively low transmission capacity is transmitted using the existing Ku broadcasting band, and the HD enhancement layer requiring relatively high transmission capacity is transmitted using the Ka band that can be easily ensured.

Hereinafter, an apparatus 13 for receiving multiband satellite broadcasting will be described.

As shown in FIG. 1, the apparatus 13 for receiving the multiband satellite broadcasting includes a subscriber Rx antenna 131, a Ku-band receiver 132, a Ka-band receiver 133, a scalable combiner 134, a demultiplexer 135 (hereinafter, referred to as a ‘Demux’, an H.264 scalable video decoder 136 and an audio decoder 137. The subscriber Rx antenna 131, the Ku-band receiver 132, the Ka-band receiver 1313 and the scalable combiner 134 may be collectively called a ‘multiband reception unit 130’.

The multiband reception unit 130 demodulates multiple satellite broadcasting reception signals received in different transmission bands, e.g., the Ku band and the Ka band, and restores corresponding packet streams. Thereafter, the multiband reception unit 130 combines those restored packet streams into a TS. This will now be described in detail.

The subscriber Rx antenna 131 simultaneously receives satellite broadcasting signals separately transmitted in the Ku band and the Ka band through a Ku-band feeder and a Ka-band feeder, respectively. The subscriber Rx antenna 131 transmits the Ku-band signal to the Ku-band receiver 132, and the Ka-band signal to the Ka-band receiver 133.

The Ku-band receiver 132 corresponds to a Ku-band tuner. The Ku-band receiver 132 performs a demodulation process of the DVB-S2 standard through a Ku-band low noises block (LNB) 1321 and a DVB-S2 receiver/demodulator #1 1322. The Ka-band receiver 133 corresponds to a Ka-band tuner. The Ka-band receiver 133 performs a demodulation process of the DVB-S2 standard through a Ka-band LNB 1331 and a DVB-S2 receiver/demodulator #2 1332. A low-noise amplifier is used as the LNB.

The Ku-band receiver 132 interprets an encoding rate and modulation information specified in a header of a received transport frame, and decodes the rest of the frame by using the interpretation result, thereby restoring a first layer (L1) packet stream. The Ka-band receiver 133 interprets an encoding rate and modulation information specified in a header of a received transport frame, and decodes the rest of the frame by using the interpretation result, thereby restoring a second layer (L2) packet stream.

Thereafter, the scalable separator 134 combines the restored first layer (L1) packet stream and second layer (L2) packet stream with reference to time information included in respective headers of the packets, thereby restoring a TS.

The DEMUX 135 demultiplexes and depacketizes the TS and splits it into an H.264 scalable video stream, i.e., a base-layer video stream and an enhancement-layer video stream, an audio stream and program specification information. The DEMUX 135 performs synchronization of audio/video and separates a video into a base-layer video stream and an enhancement-layer video stream based on information included in a packetized elementary stream (PES) header or a header of each TS packet.

Base-layer video packets and enhancement-layer video packets of the same image have the same time information value in their respective PES headers. The DEMUX 135 examines the enhancement-layer video stream packets for error and loss, discards an invalid PES packet, and converts only a valid PES packet into a video stream to transmit the converted video stream to the H.264 scalable video decoder 136.

The H.264 scalable video decoder 136 decodes the restored H.264 scalable video stream into video data. That is, if both a base-layer video stream and an enhancement-layer video are transmitted, the H.264 scalable video decoder 134 decodes and combines them to generate an HD video. If only a base-layer video stream is transmitted, the H.264 scalable video decoder 134 decodes the transmitted base-layer video stream to generate an SD video.

The audio decoder 137 decodes an audio stream into audio data.

FIG. 2 illustrates a TS generated at the MUX 114 of FIG. 1, in accordance with an embodiment of the present invention.

The MUX 114 of FIG. 1 packetizes and multiplexes program specification information, i.e., a stream map, a compressed and encoded SVC video stream, i.e., a base-layer video stream and an enhancement-layer video stream, and an audio stream, thereby generating an MPEG-2 TS. Different program identifications (PIDs) are allocated to a video stream corresponding to a base layer, a video stream corresponding to an enhancement layer, and an audio stream.

The MUX 114 packetizes the base-layer video stream, the enhancement video stream and the audio stream output from the encoders 112 and 113 into respective PES packets 210. Thereafter, the MUX 114 packetizes the PES packets 210 into TS packets 220. One PES packet is packetized into one or more TS packets.

That is, as shown in FIG. 2, the TS generated at the MUX 114 includes an audio TS packet, a base-layer video TS packet and an enhancement-layer video TS packet each having a different PID. The program specification information is included in a header of the TS packet.

Through the reverse operation of the operation illustrated in FIG. 2, the DEMUX 135 splits the transmission stream (TS) into the H.264 scalable video stream, i.e., the base-layer video stream and the enhancement-layer video stream, the audio stream and the program specification information.

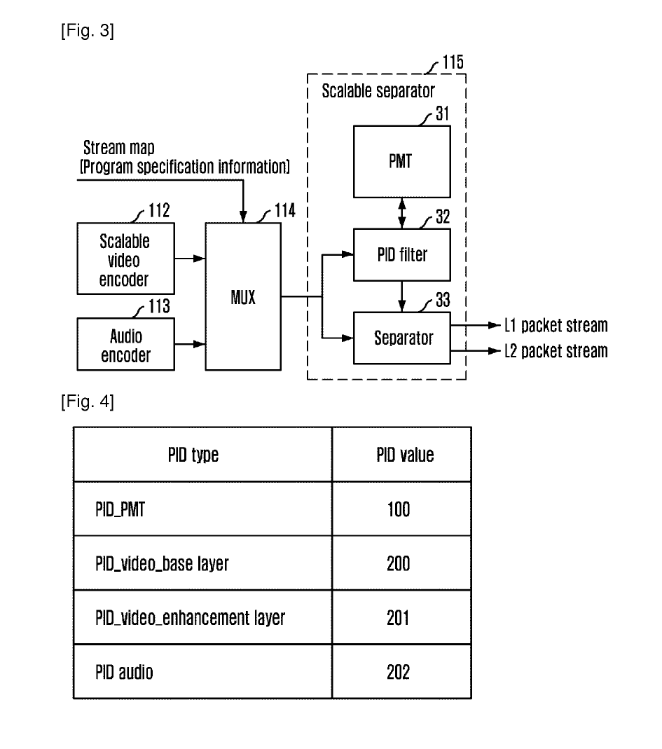

FIG. 3 is a block diagram illustrating the scalable separator 115 of FIG. 1 in accordance with an embodiment of the present invention.

Through a PID filter 32, the scalable separator 115 detects packets including program specification information (PSI) and stores PID information allocated to a base-layer video packet, an enhancement-layer video packet and an audio packet of the program specification information in a program map table (PMT) 31.

The PID filter 32 compares a PID of a packet input from the MUX 114 with PID information stored in the PMT 31 to confirm a packet type, and controls a separator 33 according to the confirmation result.

Then, the separator 33 outputs a program specification information packet, an audio packet and a base-layer video packet as the first layer (L1) and outputs an enhancement-layer video packet as the second layer (L2) under the control of the PID filter 32. The separator 33 is a kind of a demultiplexer (Demux).

If the present invention is expanded for application to multichannel broadcasting, the PMT stores therein specification information of every program, and the PID filter 32 provides control regardless of a program type such that every packet corresponding to the program specification information/base-layer video/audio packet is output as the first layer (L1) and every packet corresponding to the enhancement-layer video is output as the second layer (L2).

FIG. 4 shows specification information of a PMT applied to the present invention.

Referring to FIG. 4, a PID type includes PIDs respectively representing a PMT packet, a base-layer video packet, an enhancement-layer video packet (PID-PMT, PID_video_base layer, PID_video_enhancement layer and PID_audio), where respective PID values thereof are ‘100’, ‘200’, ‘201’ and ‘202’.

The PID filter 32 of the scalable separator 115 checks a PID value of a packet input from the MUX 114 to recognize a type of the corresponding packet, and separates the packet by layer according to the recognition result. For example, if the PID value of a packet is ‘200’, the packet is recognized as a base-layer video packet and is classified as the first layer (L1).

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media.

The present application contains subject matter related to Korean Patent Application No. 2007-0133763, filed in the Korean Intellectual Property Office on Dec. 18, 2007, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

1. An apparatus for transmitting multiband broadcasting based on scalable video coding, the apparatus comprising:
a scalable video encoder for scalably encoding video data to generate a scalable video stream having multiple layers;
a multiplexer for multiplexing the scalable video stream having multiple layers, a compressed audio elementary stream, and program specification information to generate a transport stream (TS); and
a multiband transmitter for separating the TS into multiple TS according to a given priority information and transmitting the packet stream using a different transmission band.

2. The apparatus of claim 1, wherein the scalable video encoder generates a base layer video stream and an enhancement layer video stream according to spatial scalable video coding (SVC).

3. The apparatus of claim 2, wherein the multiband transmitter comprises:
a scalable separator for classifying a packet corresponding to the program specification information and the base-layer video stream as a first layer packet stream and classifying a packet corresponding to the enhancement layer video stream as a second layer packet stream;
a first band transmitter for transmitting the first layer packet stream using a first band; and
a second band transmitter for transmitting the second layer packet stream using a second band.

4. The apparatus of claim 3, wherein the scalable separator performs packet classification by using program identification (PID) information allocated to each TS packet.

5. The apparatus of claim 3, wherein the first band and the second band are a Ku band and a Ka band in multiband satellite broadcasting, respectively.

6. The apparatus of claim 3, wherein the first band transmitter and the second band transmitter use different transmission schemes.

7. An apparatus for receiving multiband broadcasting service using scalable video coding, the apparatus comprising:
a multiband receiver for restoring packet streams from broadcasting signals transmitted through different frequency bands and combining the restored packet streams to restore a single transport stream (TS);
a demultiplexer for splitting the restored single TS into scalable video streams having multiple layers and program specification information; and
a video decoder for decoding the scalable video streams having multiple layers.

8. The apparatus of claim 7, wherein the multiband receiver comprises:
a first band receiver for receiving and demodulating a first band broadcasting signal to restore a first layer packet stream including a base layer video stream and program specification information;
a second band receiver for receiving and demodulating a second band broadcasting signal to restore a second layer packet stream including an enhancement layer video stream; and a scalable combiner combining the first layer packet stream and the second layer packet stream based on time information of a packet header to generate the TS.

9. The apparatus of claim 8, wherein the demultiplexer splits the TS into the base layer video stream, the program specification information, and the enhancement layer video stream.

10. The apparatus of claim 9, wherein the demultiplexer examines the enhancement layer video stream for a packet error, and discards a packet from which an error is detected.

11. The apparatus of claim 8, wherein the first band broadcasting signal and the second band broadcasting signal are satellite broadcasting signals received in a Ku band and a Ka band in multiband satellite broadcasting, respectively.

12. A method of transmitting multiband satellite broadcasting based on scalable video coding, the method comprising:
scalably encoding video data to generate scalable video stream having multiple layers;
multiplexing the generated scalable video elementary stream having multiple layers, compressed audio elementary stream, and program specification information to generate a transport stream (TS); and
separating the TS into multiple TSs according to pre-given priority information and transmitting the packets using a different transmission band for each layer.

13. The method of claim 12, wherein said encoding of the video data comprises generating a base layer video stream and an enhancement layer video stream according to spatial scalable video coding (SVC).

14. The method of claim 13, wherein said transmitting of the packets comprises:
classifying a packet corresponding to the program specification information and the base layer video stream as a first layer packet stream and transmitting the first layer packet stream using a first band; and
classifying a packet corresponding to the enhancement layer video stream as a second layer packet stream and transmitting the second layer packet stream using a second band.

15. The method of claim 14, wherein the first band and the second band are a Ku band and a Ka band in multiband satellite broadcasting, respectively.

16. The method of claim 14, wherein the first layer packet stream and the second layer packet stream are transmitted by different transmission schemes.
